(19) United States
(12) Patent Application Publication
(10) Pub. No.: US 2022/0050809 A1
(43) Pub. Date: Feb. 17, 2022

(54) DISTRIBUTED METADATA MANAGEMENT CONSISTENCY ASSURANCE METHOD, DEVICE, SYSTEM AND APPLICATION

(71) Applicant: SUN YAT-SEN UNIVERSITY, Guangdong (CN)

(72) Inventors: Yutong LU, Guangdong (CN); Zhiguang CHEN, Guangdong (CN); Nong XIAO, Guangdong (CN); Fang LIU, Guangdong (CN)

(73) Assignee: SUN YAT-SEN UNIVERSITY, Guangdong (CN)

(21) Appl. No.: 17/274,434

(22) PCT Filed: Mar. 20, 2019
(86) PCT No.: PCT/CN2019/078843

§ 371 Date: Mar. 9, 2021

(30) Foreign Application Priority Data
Dec. 13, 2018 (CN) 201811525115.7

(51) Int. Cl. G06F 16/16; G06F 16/11; G06F 16/17

(52) U.S. Cl. CPC G06F 16/164; G06F 16/1734; G06F 16/162; G06F 16/125

(57) ABSTRACT

A distributed metadata management consistency assurance method, device, system and application are provided. A consistent node is deployed in a metadata cluster, the client sends a metadata update request to the consistent node, and the consistent node returns a metadata update success message to the client, sequentially records the metadata update request, marks old metadata as invalidated, and deletes the invalidation mark after asynchronous data synchronization with the metadata server. The client sends a metadata read operation to the metadata server. If an object of the metadata read operation is marked as invalidated, read data that has not yet completed asynchronous data synchronization is returned via the consistent node; otherwise, the read data is directly returned via the metadata server where the metadata is located. The disclosure can ensure consistency of distributed metadata management, and improve metadata access performance as far as possible while ensuring the consistency of metadata update.

### BACKGROUND

### Technical Field

The present invention relates to the field of file system for large-scale data storage, in particular to a distributed metadata management consistency assurance method, device, system and application for ensuring metadata consistency at a very low overhead by introducing a consistent node into a metadata cluster of a distributed file system.

### Description of Related Art

With the increasing amount of data accumulated by human society, the scale of storage systems is getting larger and larger, and construction of scalable storage systems has gradually attracted the attention of the academia and the industry. As an important means to achieve scalable storage, distributed file systems have attracted extensive attention. Traditional distributed file systems such as GFS, Lustre, GPFS and PVFS use one metadata server, and this centralized metadata management method has become a main obstacle to performance expansion of the distributed file systems. In recent years, a variety of file systems have introduced distributed metadata management means. For example, the improved version of Lustre can support multiple metadata servers, and distributes a file system directory tree to each metadata server by means of subtree partition; CephFS is based on the subtree partition, and can implement live migration of subtrees among the metadata servers; and GlusterFS uses a centerless architecture, and any node in a file system cluster can be used as a metadata server. Each of the above methods provides a solution for implementing scalable metadata services, but little attention is paid to data consistency among multiple metadata servers.

Consistency of file system metadata has long been a topic of concern in the academia. Most of metadata update operations involve multiple write disk operations which can cause system failures at any time during execution. When a system failure occurs, if only part of the write operations is persisted to the disk, data inconsistency will occur after the system restarts. To solve this problem, current file systems generally adopt a logging mechanism to ensure the metadata consistency. That is, when an upper application requests the file system to update the metadata, the file system first assembles all write operations corresponding to the metadata update into a transaction, and then encapsulates the transaction into a unique write operation which can be executed atomically. If the unique write operation is successfully persisted to a storage device, the corresponding metadata update can finally be reflected in the file system; and if a system failure occurs during the unique write operation, the corresponding metadata update will eventually fail without any changes to the file system. In summary, the logging mechanism can ensure that the metadata update to the file system either execute completely successfully or fail without any impact on the file system, which will not cause inconsistency to the file system metadata.

In the context of a distributed file system, the metadata update operation is committed on a client and executed by a remote metadata server. During this process, a failure of any node on the client and the metadata server may lead to metadata inconsistency. For this scenario, the client generally sends the update operation to the metadata server. After receiving corresponding update request, the metadata server will persist an update log to the storage device, and then send a confirmation message to the client. After receiving the confirmation message, the client can confirm that the update operation can be successfully executed. When the distributed file system has only one metadata server, the above mechanism enables consistent updates of the metadata after two network interactions. However, the current distributed file systems tend to adopt multiple metadata servers in order to improve scalability. At this time, in order to ensure consistency of the metadata update, a “two-phase commit” protocol is generally adopted. The “two-phase commit” protocol is widely used to ensure the consistency of distributed transactions. In the distributed file system, when the client makes a metadata update request, file metadata on the multiple metadata servers may need to be updated. Specifically, the “two-phase commit” protocol is as follows: the client sends an update request to each involved metadata server respectively. After receiving the update request, the metadata servers persist the update operations to respective storage devices in the form of log, and then notify the client of completion of log persistence on the metadata servers. After receiving log persistence success messages from all the metadata servers, the client determines that the update operation can be successfully executed on all involved metadata servers, and then notifies all the metadata servers of truly executing the metadata update operations, and finally, the metadata servers need to confirm to the client that they have received the instruction to execute the metadata update operation. The above process can ensure the consistency of the metadata updates in the context of multiple metadata servers, but it is difficult to guarantee performance of the metadata updates. Firstly, the “two-phase commit” protocol involves multiple network interactions, which will significantly increase delay of the metadata update. Secondly, one metadata update operation may involve multiple metadata servers. The entire metadata update operation is not completed until all log persistence operations on all the metadata servers have completed. Therefore, once a metadata server responds slowly due to high load, such case will increase delay of the entire metadata update operation. In conclusion, in the context of the distributed metadata management, it is difficult for the prior art to simultaneously maintain the consistency and high performance of the metadata update.

### SUMMARY

The technical problem to be solved by the present invention is to provide a distributed metadata management consistency assurance method, device, system and application for the above problems of the prior art. The present invention can ensure consistency of distributed metadata management, and improve metadata access performance as far as possible while ensuring the consistency of metadata update.

In order to solve the above problems, the present invention adopts the following technical solutions.

A distributed metadata management consistency assurance method, comprises the following implementation steps:

1) intercepting a metadata operation request from a client, turning to step 2) if the metadata operation request is a metadata update operation; or turning to step 3) if the metadata operation request is a metadata read operation for marked invalidated metadata;

2) returning a metadata update success message to the client, sequentially recording a metadata update request, marking old metadata stored in a metadata server where the metadata is located as invalidated, asynchronously synchronizing the sequentially recorded metadata update request to the metadata server where the metadata is located, and deleting an invalidation mark of the synchronized metadata; and quitting; and

3) returning the metadata that has not completed asynchronous synchronization to the client and quitting.

Preferably, detailed steps of the step 2) comprise:

2.1) returning the metadata update success message to the client;

2.2) encapsulating the metadata update operation into a log, and persisting the log to a storage device with an atomic write operation so that the metadata update request has been persisted to a metadata cluster under the condition of ensuring consistency;

2.3) sending an invalidation message to the metadata server where the metadata is located, and marking the old metadata stored in the metadata server where the metadata is located as invalidated; and

2.4) asynchronously synchronizing the sequentially recorded metadata update request to the metadata server where the metadata is located periodically, and deleting the invalidation mark of the synchronized metadata; and quitting.

The present invention also provides a distributed metadata management consistency assurance device, comprising:

an operation request judgment program unit configured to intercept a metadata operation request from a client, turn to execute an update operation processing program unit if the metadata operation request is a metadata update operation, or turn to execute a read operation processing program unit if the metadata operation request is a metadata read operation;

the update operation processing program unit configured to return a metadata update success message to the client, sequentially record the metadata update request, and mark old metadata stored in a metadata server where the metadata is located as invalidated; and asynchronously synchronize the sequentially recorded metadata update request to the metadata server where the metadata is located, and delete an invalidation mark of the synchronized metadata; and

the read operation processing program unit configured to return the metadata that has not completed asynchronous synchronization to the client.

The present invention also provides a distributed metadata management consistency assurance device, comprising a consistency assurance node composed of at least one computer installation, and the consistency assurance node is programmed to execute the steps of the distributed metadata management consistency assurance method of the present invention.

The present invention also provides a distributed metadata management consistency assurance system, comprising a client and at least one metadata server, and the client and the metadata server are connected with the consistency assurance node of the present invention therebetween.

The present invention also provides an application method of the distributed metadata management consistency assurance system, comprising the following implementation steps:

S1) the client judges type of a metadata operation request to be initiated, turns to execute step S2) if the metadata operation request is a metadata update operation, or turns to execute step S3) if the metadata operation request is a metadata read operation;

S2) the client selects one consistency assurance node and sends the metadata update operation to the selected consistency assurance node, and ends and quits after receiving a metadata update success message from the consistency assurance node;

S3) the client sends the metadata read operation to a target metadata server of the metadata read operation;

S4) the target metadata server judges whether there is an invalidation mark on target metadata of the metadata read operation, returns client target metadata to the client if there is no invalidation mark on the target metadata, and the client ends and quits after receiving the returned target metadata; the target metadata server returns a target metadata invalidation message to the client if there is the invalidation mark on the target metadata; and the client turns to execute step S5) after receiving the returned target metadata invalidation message; and

S5) the client selects one consistency assurance node, sends the metadata read operation for the marked invalidated metadata to the selected consistency assurance node, and ends and quits after receiving the metadata returned by the consistency assurance node to the client that has not completed asynchronous synchronization.

Preferably, when the client selects one consistency assurance node in the step S2) and the step S5), the client selects a corresponding consistent node according to a filename of the metadata update operation or the metadata read operation.

Preferably, the step of selecting the corresponding consistent node according to the filename of the metadata update operation or the metadata read operation specifically refers to using a Hash function h(x) to select the consistent node numbered as h(filename)%N for the filename of the metadata update operation or the metadata read operation, where % is a remainder symbol and N is the number of consistent nodes in a metadata cluster.

Compared with the prior art, the present invention has the following advantages.

1. There is only a single network interaction on a critical path of metadata update, ensuring a lower metadata update delay. Under the technical solution of the present invention, no matter how many metadata servers are involved in the metadata update, the client only needs to experience a single network interaction with one consistent node on the critical path of metadata update. After the network interaction is completed, the latest metadata has been persisted to the consistent node, and the client can turn to execute other tasks. In contrast, for traditional file systems, if the metadata update involves multiple metadata servers, the client needs to interact with the metadata servers respectively, and has to wait for all interactions to complete before the client determines that the metadata update is completed. The lag of any metadata server will increase the metadata update delay.

2. There is only a single write operation on the critical path of metadata update, ensuring a lower metadata update delay. Under the technical solution of the present invention, no matter how many metadata servers are involved in the metadata update, the client only needs to send one write request to one consistent node on the critical path of metadata update, that is, the consistent node encapsulates the metadata update operation into a log, writes the log to the storage device as an atomic operation, and the write operation is committed to the storage device in the form of sequential write, which can maximize efficiency of the storage device. In contrast, for the traditional file systems, if the metadata update involves multiple metadata servers, the client needs to commit a write request to the metadata servers respectively. If any write request is not completed, the metadata update cannot be confirmed completed.

3. The present invention can implement metadata read/write splitting, reduce sudden load of the metadata servers to a certain extent, and give full play to the performance of solid state disks. Under the technical solution of the present invention, the metadata update operation is first sent to the consistent node, and then asynchronously updated to the metadata server, and a metadata acquisition operation is directly sent to the metadata server. When read load on the metadata server is heavy, the latest data on the consistent node can be updated to the metadata server later, and this strategy implements the metadata read/write splitting to a certain extent.

The read/write splitting has at least two advantages: \textcircled{1} delaying write load when read load is heavy to reduce peak load of the metadata server; and \textcircled{2} implementing the read/write splitting on the solid state disk can give full play to advantages of concurrency of the solid state disk. The present invention is conducive to improving performance of the metadata server using the solid state disk as the storage device.

### BRIEF DESCRIPTION OF THE DRAWINGS

FIG. 1 is a structural diagram of a metadata cluster in an embodiment of the present invention.

FIG. 2 is a schematic diagram showing basic process of a method in an embodiment of the present invention.

FIG. 3 is a schematic diagram showing metadata update process in an embodiment of the present invention.

FIG. 4 is a schematic diagram showing metadata read process in an embodiment of the invention.

### DESCRIPTION OF THE EMBODIMENTS

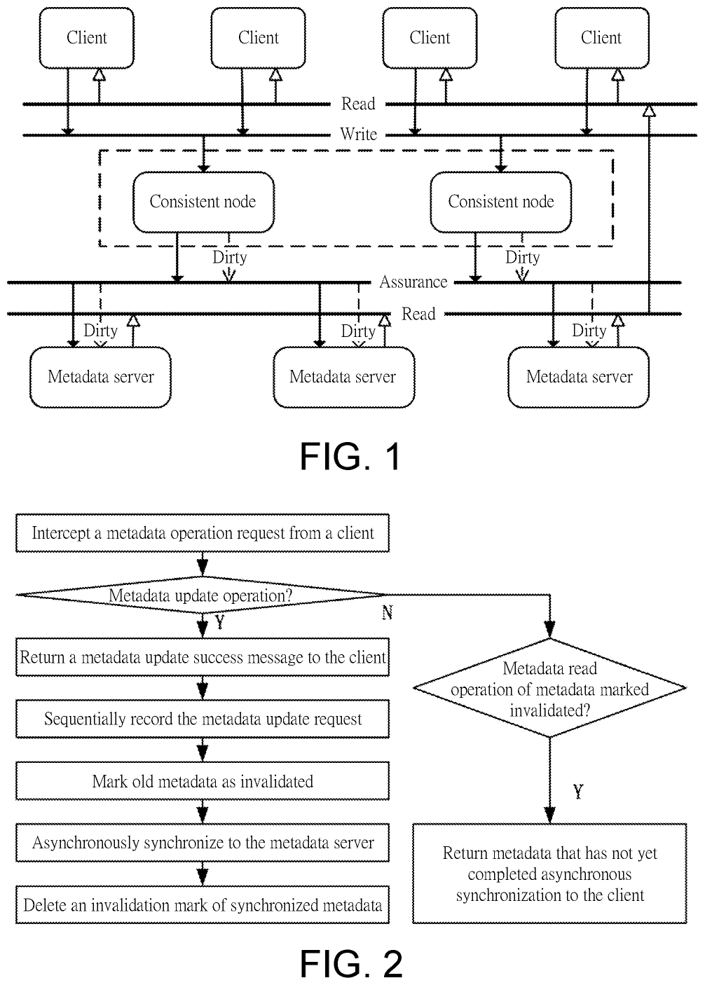

Traditional large-scale file systems consist of three nodes namely clients, metadata servers and data servers. The client is the initiator of all read-write requests. The metadata server is responsible for storing file metadata and responding to metadata requests from the client. The data server is responsible for storing the file data and responding to the data requests from the client. In the present embodiment, a new node named consistent node is introduced on the basis of the above infrastructure of the traditional large-scale file system to execute metadata management consistency assurance, and the specific architecture is shown in FIG. 1. FIG. 1 shows architecture of a file system consisting of 4 clients, 3 metadata servers and 2 consistent nodes, in which dirty represents dirty data, and the data server is ignored as it does not involve the related art of the present invention. In the architecture, functions of the client and the metadata server are the same as those of the traditional file systems, the consistent nodes and the metadata servers jointly form a metadata cluster, and the consistent nodes are mainly configured to ensure metadata consistency at low overhead in metadata update.

As shown in FIG. 2, a distributed metadata management consistency assurance method in the present embodiment comprises the following implementation steps:

1) intercepting a metadata operation request from a client, turning to step 2) if the metadata operation request is a metadata update operation; or turning to step 3) if the metadata operation request is a metadata read operation for marked invalidated metadata;

2) returning a metadata update success message to the client, sequentially recording the metadata update request, marking old metadata stored in a metadata server where the metadata is located as invalidated, asynchronously synchronizing the sequentially recorded metadata update request to the metadata server where the metadata is located, and deleting an invalidation mark of the synchronized metadata; and quitting; and

3) returning the metadata that has not completed asynchronous synchronization to the client and quitting. It should be noted that in the present embodiment, the metadata read operation of the client is preferably sent to the metadata server. Only when the metadata server confirms that the metadata is marked as invalidated, the client will send the metadata read operation to the consistent node.

The distributed metadata management consistency assurance method of the present embodiment firstly proposes the above large-scale file system architecture with an introduction of consistent nodes, based on which a new metadata read-write process is designed with consistency and high performance taken into account.

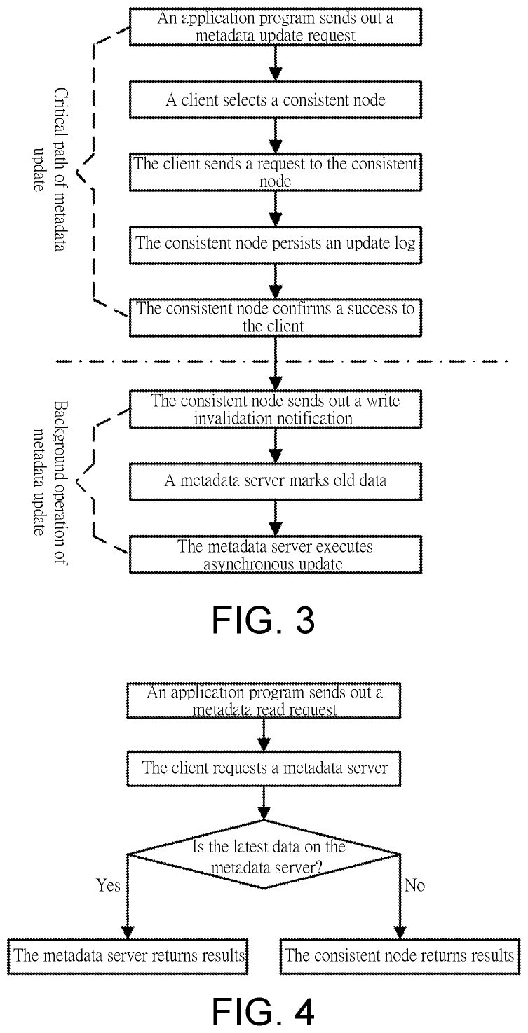

As shown in FIG. 3, detailed steps of the step 2) comprise:

2.1) returning the metadata update success message to the client;

2.2) encapsulating the metadata update operation into a log, and persisting the log to a storage device with an atomic write operation so that the metadata update request has been persisted to a metadata cluster under the condition of ensuring consistency;

2.3) sending an invalidation message to the metadata server where the metadata is located, and marking the old metadata stored in the metadata server where the metadata is located as invalidated (a read-write storage device is not required in this step); and

2.4) asynchronously synchronizing the sequentially recorded metadata update request to the metadata server where the metadata is located periodically, and deleting the invalidation mark of the synchronized metadata; and quitting.

Correspondingly, the present embodiment also provides a distributed metadata management consistency assurance device, comprising:

an operation request judgment program unit configured to intercept a metadata operation request from a client, turn to execute an update operation processing program unit if the metadata operation request is a metadata update operation, or turn to execute a read operation processing program unit if the metadata operation request is a metadata read operation;

the update operation processing program unit configured to return a metadata update success message to the client, sequentially record the metadata update request, and mark old metadata stored in a metadata server where the metadata is located as invalidated; and asynchronously synchronize the sequentially recorded metadata update request to the metadata server where the metadata is located, and delete an invalidation mark of the synchronized metadata; and

the read operation processing program unit configured to return the metadata that has not completed asynchronous synchronization to the client.

As shown in FIG. 2, the present embodiment also provides a distributed metadata management consistency assurance device, comprising a consistency assurance node composed of at least one computer installation, and the consistency assurance node is programmed to execute the steps of the distributed metadata management consistency assurance method of the present embodiment.

As shown in FIG. 3 and FIG. 4, the present embodiment also provides an application method of the distributed metadata management consistency assurance system, comprising the following implementation steps:

S1) the client judges type of a metadata operation request to be initiated, turns to execute step S2) if the metadata operation request is a metadata update operation, or turns to execute step S3) if the metadata operation request is a metadata read operation;

S2) the client selects one consistency assurance node and sends the metadata update operation to the selected consistency assurance node, and ends and quits after receiving a metadata update success message from the consistency assurance node;

S3) the client sends the metadata read operation to a target metadata server of the metadata read operation;

S4) the target metadata server judges whether there is an invalidation mark on target metadata of the metadata read operation, returns client target metadata to the client if there is no invalidation mark on the target metadata, and the client ends and quits after receiving the returned target metadata; the target metadata server returns a target metadata invalidation message to the client if there is the invalidation mark on the target metadata; and the client turns to execute step S5) after receiving the returned target metadata invalidation message; and

S5) the client selects one consistency assurance node, sends the metadata read operation for the marked invalidated metadata to the selected consistency assurance node, and ends and quits after receiving the metadata returned by the consistency assurance node to the client that has not completed asynchronous synchronization.

In the present embodiment, when the client selects one consistency assurance node in the step S2) and the step S5), specifically the client selects a corresponding consistent node according to a filename of the metadata update operation or the metadata read operation, and by which load balance of multiple consistent nodes can be implemented.

In the present embodiment, the step of selecting the corresponding consistent node according to the filename of the metadata update operation or the metadata read operation specifically refers to using a Hash function h(x) to select the consistent node numbered as h(filename)%N for the filename of the metadata update operation or the metadata read operation, where % is a remainder symbol and N is the number of consistent nodes in a metadata cluster. The advantages resulting from use of such method is as follows: when the client reads the metadata cluster and finds that the requested metadata is located on the consistent node but has not been synchronized to the metadata server, the latest metadata can be obtained by determining the consistent node where the latest updated data is located by means of hashing of the filename. This method of locating the latest metadata only by the filename does not result in additional storage and IO overhead.

In the present embodiment, an application program of the client sends out the metadata update request through a system call which is embedded into the client of the distributed file system as designed by the present invention through a virtual file system.

In the distributed file system with the consistent node as designed in the present embodiment, when the client sends out the metadata update request, an update log is first sent to the consistent node (in contrast, the traditional distributed file system sends the update request directly from the client to the metadata server). After receiving the update log, the consistent node quickly persists the update log to a local storage device. Once the persistence operation succeeds, a confirmation message of metadata update operation success is returned to the client. Two features exist in the metadata update process to ensure that the metadata update can achieve higher performance: first, no matter how many metadata servers are involved in the metadata update operation, the client only needs to interact with one consistent node, and only needs a single network interaction, and network delay is significantly reduced; and secondly, the persistence operation on the consistent node is sequential write of the log. The sequential write operation can achieve good performance on all storage devices, thus further reducing the delay of the metadata update persistence. So far, the metadata update sent by the client is only reflected in the consistent node, and have not been committed to the metadata server. However, from the perspective of the whole metadata cluster, update status has been recorded under the condition of ensuring consistency and persistence, and the remaining work is to implement the data synchronization between the consistent node and the metadata server in the metadata cluster. As the consistent node has informed the client of the persistence of the updated metadata to the metadata cluster, the client does not have to wait for the updated metadata to be synchronized from the consistent node to the metadata server, and can directly turn to execute other tasks. Therefore, the data synchronization from the consistent node to the metadata server does not occur on the critical IO path and can be executed asynchronously. In the present embodiment, the update log on the consistent node is committed to the metadata server when the metadata server has relatively light load. As the data synchronization from the consistent node to the metadata server is asynchronous, the update status of the metadata server lags slightly behind that of the consistent node. The client cannot get the latest metadata when the client reads the metadata server for a period when the consistent node and the metadata server are asynchronous. In order to reduce negative impact of asynchronous data update, in the present embodiment, after the metadata update log is persisted to the consistent node, the consistent node immediately sends a notification to the metadata server, informing that the metadata update has been persisted to the consistent node, but the metadata update will be synchronized to the metadata server in a lagging manner. The above notification can be completed through a single network interaction, and the metadata server only needs to record this information in a memory after receiving the notification without the need of a read-write storage device, so it will not bring too much overhead. In the present embodiment, as the metadata update request for sequential record is asynchronously synchronized with the metadata server where the metadata is located, the metadata update request can be synchronized to the metadata server when the metadata server is relatively idle.

The metadata cluster designed according to the present embodiment comprises a consistent node and a metadata server, and data between such two nodes may be asynchronous, but data asynchronization can only occur on the recently updated metadata, and most of the latest version of metadata are still saved on the metadata server. Therefore, the client still interacts with the metadata server first when the client initiates a metadata read request. In the memory of the metadata server, there are marks to indicate which metadata has been persisted to the consistent node but has not yet been synchronized to the metadata server. If the metadata requested by the client falls into such class, the metadata server will take the initiative to obtain the latest metadata from the consistent node and return latest metadata to the client, and update the metadata saved by itself to the latest state. If the metadata saved by the metadata server itself is the latest version (that is, there is no mark in the memory indicating that the latest version of the metadata is on the consistent node), the latest version can be returned directly to the client.

The above are only preferred embodiments of the present invention, and the protection scope of the present invention is not limited to the embodiments mentioned above. The technical solutions under the ideas of the present invention fall into the protection scope of the present invention. It should be pointed out that, for an ordinary person skilled in the art, some improvements and modifications without departing from the principle of the present invention shall be deemed as the protection scope of the present invention.

1. A distributed metadata management consistency assurance method, characterized in that, comprises following implementation steps:
1) intercepting a metadata operation request from a client, turning to step 2) if the metadata operation request is a metadata update operation; or turning to step 3) if the metadata operation request is a metadata read operation for marked invalidated metadata;
2) returning a metadata update success message to the client, sequentially recording the metadata update request, marking old metadata stored in a metadata server where the metadata is located as invalidated, asynchronously synchronizing the sequentially recorded metadata update request to the metadata server where the metadata is located, and deleting an invalidation mark of the synchronized metadata; and quitting; and
3) returning the metadata that has not completed asynchronous synchronization to the client and quitting.

2. The distributed metadata management consistency assurance method according to claim 1, wherein characterized in that, detailed steps of the step 2) comprise:
2.1) returning the metadata update success message to the client;
2.2) encapsulating the metadata update operation into a log, and persisting the log to a storage device with an atomic write operation so that the metadata update request has been persisted to a metadata cluster under the condition of ensuring consistency;
2.3) sending an invalidation message to the metadata server where the metadata is located, and marking the old metadata stored in the metadata server where the metadata is located as invalidated; and
2.4) asynchronously synchronizing the sequentially recorded metadata update request to the metadata server where the metadata is located periodically, and deleting the invalidation mark of the synchronized metadata; and quitting.

3. A distributed metadata management consistency assurance device, characterized in that, comprising:
an operation request judgment program unit configured to intercept a metadata operation request from a client, turn to execute an update operation processing program unit if the metadata operation request is a metadata update operation, or turn to execute a read operation processing program unit if the metadata operation request is a metadata read operation;
the update operation processing program unit configured to return a metadata update success message to the client, sequentially record the metadata update request, and mark old metadata stored in a metadata server where the metadata is located as invalidated; and asynchronously synchronize the sequentially recorded metadata update request to the metadata server where the metadata is located, and delete an invalidation mark of the synchronized metadata; and
the read operation processing program unit configured to return the metadata that has not completed asynchronous synchronization to the client.

4. A distributed metadata management consistency assurance device, comprising a consistent node composed of at least one computer installation, characterized in that, the consistent node is programmed to execute following implementation steps:
1) intercepting a metadata operation request from a client, turning to step 2) if the metadata operation request is a metadata update operation; or turning to step 3) if the metadata operation request is a metadata read operation for marked invalidated metadata;
2) returning a metadata update success message to the client, sequentially recording a metadata update request, marking old metadata stored in a metadata server where the metadata is located as invalidated, asynchronously synchronizing the sequentially recorded metadata update request to the metadata server where the metadata is located, and deleting an invalidation mark of the synchronized metadata; and quitting; and
3) returning the metadata that has not completed asynchronous synchronization to the client and quitting.

5. A distributed metadata management consistency assurance system, comprising a client and at least one metadata server, wherein the client and the metadata server are connected with the consistent node according to claim 4.

6. An application method of the distributed metadata management consistency assurance system, wherein the distributed metadata management consistency assurance system comprises a client and at least one metadata server, and the application method comprises following implementation steps:
S1) the client judges type of a metadata operation request to be initiated, turns to execute step S2) if the metadata operation request is a metadata update operation, or turns to execute step S3) if the metadata operation request is a metadata read operation;
S2) the client selects one consistent node and sends the metadata update operation to the selected consistent node, and ends and quits after receiving a metadata update success message from the consistent node;
S3) the client sends the metadata read operation to a target metadata server of the metadata read operation;
S4) the target metadata server judges whether there is an invalidation mark on target metadata of the metadata read operation, returns client target metadata to the client if there is no invalidation mark on the target metadata, and the client ends and quits after receiving the returned target metadata; the target metadata server returns a target metadata invalidation message to the client if there is the invalidation mark on the target metadata;
and the client turns to execute step S5) after receiving the returned target metadata invalidation message; and
S5) the client selects another one consistent node, sends the metadata read operation for the marked invalidated metadata to the selected another one consistent node, and ends and quits after receiving the metadata returned by the another one consistent node to the client that has not completed asynchronous synchronization.

7. The application method of the distributed metadata management consistency assurance system according to claim 6, wherein when the client selects the one consistent node in the step S2) and selects the another one consistent node in the step S5), the client selects a corresponding consistent node according to a filename of the metadata update operation or the metadata read operation.

8. The application method of the distributed metadata management consistency assurance system according to claim 7,wherein the step of selecting the corresponding consistent node according to the filename of the metadata update operation or the metadata read operation specifically refers to using a Hash function h(x) to select the consistent node numbered as h(filename)%N for the filename of the metadata update operation or the metadata read operation, where % is a remainder symbol and N is the number of consistent nodes in a metadata cluster.
